(19) United States
(12) Patent Application Publication
(10) Pub. No.: US 2007/0163865 A1
(43) Pub. Date: Jul. 19, 2007

(54) Thin film circuit board of keyboard

(76) Inventor: Huo-Lu Tsai, Daya Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/333,670

(22) Filed: Jan. 17, 2006

(51) Int. Cl. H01H 9/00

(52) U.S. Cl. 200/292

(57) ABSTRACT

A thin film circuit board of the keyboard includes an upper thin film laminate, a lower thin film laminate and an insulation partition between the upper thin film laminate and the lower thin film laminate. Multiple first/second circuits are formed on the upper/lower thin film laminates. The first circuits and the second circuits respectively have at least a first connection terminal and a second connection terminal. The two first connection terminals and second connection terminals are coupled together by conductive adhesive or by external force of pressure.

### BACKGROUND OF THE INVENTION

1. Field of the Invention

The invention relates in general to a thin film circuit board of a keyboard, and more particularly to a thin film circuit board that ensures multiple circuits able to be coupled together and provide a good functionality when the keyboard is used.

2. Description of the Related Art

With the advent of very low cost electronic integrated circuit technology, all kinds of electronic products such as computers have become popular to consumers. Keyboards which provide a standard input interface for the computers are widely used. A general standard structure of the keyboards includes a bottom board, an upper housing mounted to the bottom board and a thin film circuit board. The upper housing forms multiple openings for setting multiple keys. The thin film circuit board is configured between the upper housing and the bottom board.

Generally speaking, the thin film circuit board is made up by flexible material such as polyester or polyimide as a substrate with an overall thickness of 0.05 mm to 1 mm. Circuits are printed on one side or both sides of the thin film circuit board. The conventional thin film circuit board is a three-layered structure including an upper circuit layer, a lower circuit layer and an insulation partition between the upper and the lower circuit layers. The upper/lower circuit layers both include multiple connection terminals; so that the two circuit layers can be electrically connected by coupling the connection terminals. However, the conventional connection manner for the connection terminals is to press the connection terminals to be coupled together by a mechanical manner, which tends to cause a bad connection. Hence the keyboards may malfunction due to the bad connection of the connection terminals.

### SUMMARY OF THE INVENTION

A main objective of the present invention is to provide a thin film circuit board of a keyboard by overlapping multiple thin film circuit laminates to make multiple printed circuits to be coupled to each other and electrically connected together properly, so as to ensure a good functionality of the keyboard.

In order to achieve the above objective, the thin film circuit board of the keyboard of the present invention includes an upper thin film laminate, a lower thin film laminate and an insulation partition between the upper thin film laminate and the lower thin film laminate.

Multiple first circuits are formed on the upper thin film laminate and multiple second circuits are formed on the lower thin film laminate. The first circuits and the second circuits respectively include at least a first connection terminal and a second connection terminal. A first opening is formed on the insulation partition corresponding to the first connection terminals of the first circuits and the second circuits, so that the two first connection terminals can be connected together by conductive adhesive through the first opening.

Further, a second opening is formed on the insulation laminate corresponding to the second connection terminals of the first circuits and the second circuits, so that the two second connection terminals can be connected together by the conductive adhesive or by external force of pressure through the second opening.

Moreover, one side of the upper/lower thin film circuit laminates can form an extending part having a connection terminal on the extending part. The two connection terminals of the two thin film circuit laminates also can be directly contacted and coupled together by bending the two extending parts together.

### BRIEF DESCRIPTION OF THE DRAWING

FIG. 1 is an exploded perspective view of a first embodiment of the thin film circuit board of a keyboard of the present invention.

FIG. 2 is a perspective view of the first embodiment of FIG. 1.

FIG. 3 is an exploded perspective view of a second embodiment of the thin film circuit board of a keyboard of the present invention.

FIG. 4 is a perspective view of the second embodiment of FIG. 4.

FIG. 5 shows a perspective view of the second embodiment of the present invention, wherein two extending parts are contacted and connected together by bending.

### DETAILED DESCRIPTION OF THE INVENTION

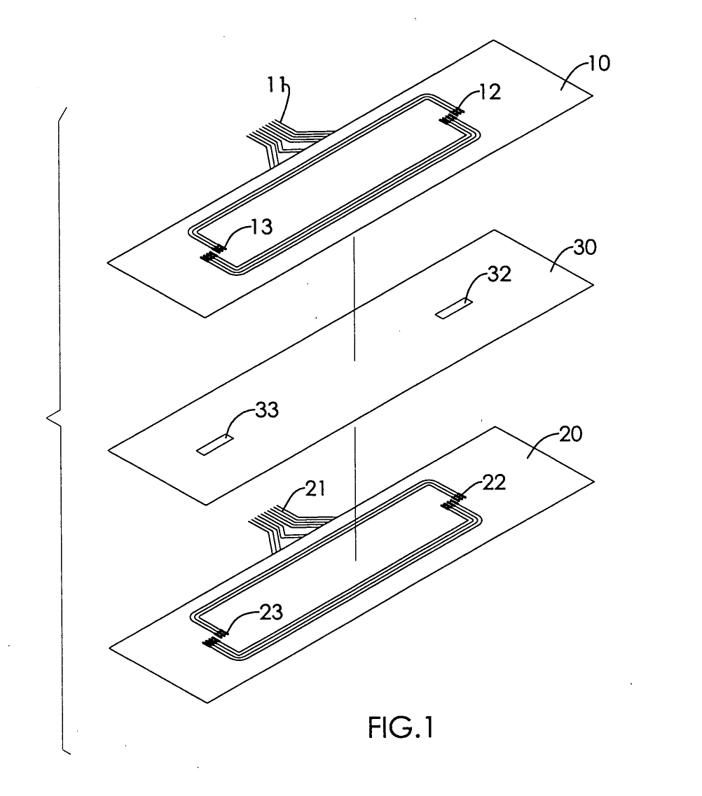

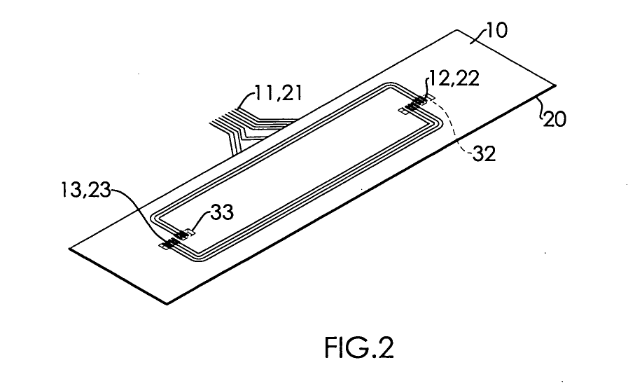

With reference to FIG. 1 and FIG. 2, a first embodiment of the present invention includes an upper thin film laminate 10, a lower thin film laminate 20 and an insulation partition 30 between the upper thin film laminate 10 and the lower thin film laminate 20. One side of the upper thin film laminate 10 extends an output cable port 11 and also one side of the lower thin film laminate 20 extends an output cable port 21 for external connecting and outputting a keyboard signal.

Multiple conductive circuit patterns are printed and formed on the upper thin film laminate 10. The circuits form a first connection terminal 12 and a second connection terminal 13.

On the other hand, a first connection terminal 22 and a second connection terminal 23 are also formed on the lower thin film circuit laminate 20 corresponding to the same positions of the upper thin film circuit laminate 10. Moreover, a first opening 32 and a second opening 33 are formed on the insulation partition 30 corresponding to the same positions of the first connection terminals 12, 22 and the second connection terminals 13, 23. In this way, the two connection terminals 12, 13 of the upper thin film circuit laminate 10 can respectively pass through the first opening 32 and the second opening 33 to be electrically connected with the two connection terminals 22, 23 of the lower thin film circuit laminate 20.

In the first embodiment, the two first connection terminals 12 and 22 can be coupled together by conductive adhesive, so as to have an effect on signal transmission. On the other hand, the two connection terminals 13 and 23 are contacted with each other by pressure, this is to provide external force of mechanical direct connection. A manner to provide the pressure is described as follows for example. An upward extending holding structure can be configured at a bottom of a keyboard (not shown in the diagram), so as to make the second connection terminal 23 of the lower thin film circuit laminate 20 move upward to get contacted with the second connection terminal 13 of the upper thin film circuit laminate 10. In this way, the second connection terminals 13 and 23 of the upper thin film circuit laminate 10 and the lower thin film circuit laminate 20 are electrically connected. In other words, this manner makes use of an upper housing and a lower housing of the keyboard to be jointed together, so as to press the two second connection terminals 13 and 23 to achieve an electricity connection. In addition, the two second connection terminals 13 and 23 also can be coupled together by the conductive adhesive to provide the effect on the signal transmission.

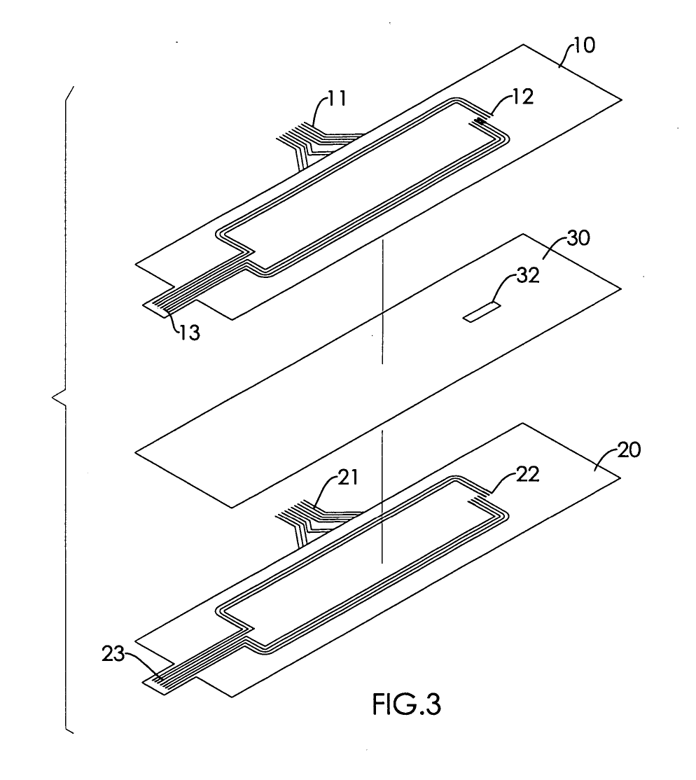

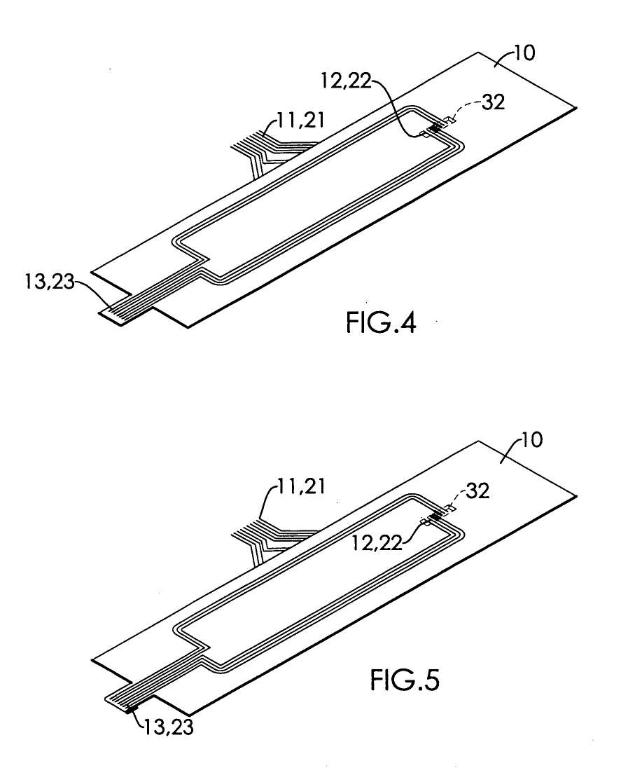

With reference to FIG. 3 and FIG. 4, a second embodiment of the present invention is similar to that of the first embodiment. First connection terminals 12 and 22 of two thin film circuit laminates 10 and 20 are coupled together by conductive adhesive. An insulation partition 30 between the two thin film circuit laminates 10 and 20 forms an opening 32, which is corresponding to the first connection terminals 12 and 22. A difference of the second preferred embodiment is that one side of the upper thin film circuit laminate 10 includes an extending part which extends outward. A second connection terminal 13 is formed on the extending part. On the other hand, one side of the lower thin film circuit laminate 20 also includes an extending part, which also forms a second connection terminal 23 on the extending part. The two second connection terminals 13 and 23 are contacted with each other to be conductive by pressure of external force.

With reference to FIG. 5, a manner to impose the pressure on the two second connection terminals 13 and 23 is shown in the diagram. After the second connection terminals 13 and 23 are correspondingly overlapped, the overlapped second connection terminals 13 and 23 are bended to be close contacted to each other. Therefore the second connection terminals 13 and 23 are electrically connected together. In order to make sure that the second connection terminals 13 and 23 include a good contact effect after the second connection terminals 13 and 23 are overlapped and bended, the upper housing and the lower housing of the keyboard is tightly pressed when the keyboard is assembled. In this way, the second connection terminals 13 and 23 can be tightly coupled to each other without separation. In addition, the two second connection terminals 13 and 23 also can be coupled together by the conductive adhesive.

In the above examples of the preferred embodiments of the present invention, every thin film circuit laminate includes two connection terminals. However, in practicable application, a quantity of the connection terminals can be added depending on an actual demand by making use of the aforesaid technique to fulfill the connection manner.

To conclude, the present invention provides the thin film circuit board having multiple connection terminals on every thin film circuit laminate to ensure that the multiple thin film circuit laminates can be electrically connected to each other. Hence the keyboard can have a good functionality. Therefore the present invention includes obvious improved features in comparison with the conventional thin film circuit board of the keyboard.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A thin film circuit board of a keyboard comprising:
an upper thin film laminate, wherein first circuits are formed on the upper thin film laminate;
a lower thin film laminate, wherein second circuits are formed on the lower thin film laminate; and
an insulation partition between the upper thin film laminate and the lower thin film laminate;
wherein the first circuits and the second circuits respectively comprise at least a first connection terminal and a second connection terminal; wherein a first opening is formed on the insulation partition corresponding to the first connection terminals of the first circuits and the second circuits, so that the two first connection terminals can be coupled together by conductive adhesive through the first opening.

2. The thin film circuit board of a keyboard as claimed in claim 1, wherein a second opening is formed on the insulation laminate corresponding to the second connection terminals of the first circuits and the second circuits, so that the two second connection terminals can be coupled together by the conductive adhesive through the second opening.

3. The thin film circuit board of a keyboard as claimed in claim 1, wherein a second opening is formed on the insulation laminate corresponding to the second connection terminals of the first circuits and the second circuits, wherein when pressure is exerted upon the second connection terminals, the second connection terminals are contacted to each other to form an electrical connection.

4. The thin film circuit board of a keyboard as claimed in claim 3, wherein the second connection terminals are connected together by shifting the second connection terminal of the lower thin film circuit laminate upward, wherein when the pressure is exerted upon the second connection terminal of the lower thin film circuit laminate, the connection terminals of the upper thin film circuit laminate and the lower thin film circuit laminate are contacted to each other to be electrically connected.

5. The thin film circuit board of a keyboard as claimed in claim 1, wherein an extending part is respectively formed on one side of the upper thin film circuit laminate and one side of the lower thin film circuit laminate, wherein a second connection terminal is formed on the extending parts of the upper thin film circuit laminate and the lower thin film circuit laminate respectively, wherein the second connection terminals of the two thin film circuit laminates are coupled to each other by the conductive adhesive through the first opening of the insulation partition.

6. The thin film circuit board of a keyboard as claimed in claim 5, wherein the first connection terminals of the two extending parts are contacted with each other to be conductive by imposing pressure on the two first connection terminals.

7. The thin film circuit board of a keyboard as claimed in claim 5, wherein the two first connection terminals are contacted to each other by overlapping and bending the two extending parts.
